(19) United States
(12) Patent Application Publication
(10) Pub. No.: US 2025/0153778 A1
(43) Pub. Date: May 15, 2025

(54) VEHICLE FRONT STRUCTURE

(71) Applicant: SUBARU CORPORATION, Tokyo (JP)

(72) Inventor: Akihiro MAEDA, Tokyo (JP)

(73) Assignee: SUBARU CORPORATION, Tokyo (JP)

(21) Appl. No.: 18/930,101

(22) Filed: Oct. 29, 2024

(30) Foreign Application Priority Data
Nov. 10, 2023 (JP) 2023-192310

(51) Int. Cl. B62D 25/08

(52) U.S. Cl. CPC B62D 25/084

(57) ABSTRACT

A vehicle front structure in which a heat exchanger is disposed includes support frames in a left and right pair. The support frames extends in a front-rear direction and supports left and right ends of the heat exchanger. The heat exchanger includes a front supported portion and a rear supported portion. Each of the support frames includes a front support body and a rear support body supporting the front supported portion and the rear supported portion. The each of the support frames includes a front bent portion that is bent to protrude upward and a rear bent portion that is bent to protrude downward when a compressive load acts on the each of the support frame. When the front bent portion and the rear bent portion are bent, the rear supported portion is detached from the rear support body, and the heat exchanger approaches a vertical posture.

### CROSS-REFERENCE TO RELATED APPLICATIONS

The present application claims priority from Japanese Patent Application No. 2023-192310 filed on Nov. 10, 2023, the entire contents of which are hereby incorporated by reference.

### BACKGROUND

The disclosure relates to a vehicle front structure in which a heat exchanger is disposed in a motor room.

Electric vehicles such as electric vehicles and hybrid vehicles equipped with a motor as a traveling power source have been widespread (for example, Japanese Unexamined Patent Application Publication (JP-A) No. 2013-193651). In an electric vehicle, a motor and a heat exchanger for cooling various apparatuses such as the motor are disposed in a motor room in a front portion of the vehicle. In the electric vehicle of JP-A 2013-193651, the heat exchanger is supported in a vertical posture in a side view in front of the motor.

### SUMMARY

An aspect of the disclosure provides a vehicle front structure. In the vehicle front structure, a heat exchanger is disposed in front of a motor in a motor room. The vehicle front structure includes support frames in a left and right pair. The support frames extend in a front-rear direction and respectively support left and right ends of the heat exchanger. The heat exchanger includes a front supported portion and a rear supported portion that are disposed in a rear upward posture in a side view, are disposed at left and right ends, and are supported by the support frames. Each of the support frames includes a front support body and a rear support body that support the front supported portion and the rear supported portion of the heat exchanger. Each of the support frames includes a front bent portion and a rear bent portion that are respectively configured to be bent in a mode of protruding upward and to be bent in a mode of protruding downward when a compressive load in the front-rear direction acts on the each of the support frame. The front support body is disposed in front of the front bent portion. The rear support body is configured such that the rear supported portion is detached from the rear support body when the front bent portion and the rear bent portion are bent. The heat exchanger is configured to approach a vertical posture from the rear upward posture in a side view when the front bent portion and the rear bent portion are bent.

### BRIEF DESCRIPTION OF THE DRAWINGS

The accompanying drawings are included to provide a further understanding of the disclosure and are incorporated in and constitute a part of this specification. The drawings illustrate an embodiment and, together with the specification, serve to describe the principles of the disclosure.

FIG. 1 is a schematic side view of a vehicle front structure illustrating an embodiment of the disclosure;

FIG. 2 is a front view of a heat exchanger;

FIG. 3 is a side cross-sectional view of a front support body;

FIG. 4 is a rear cross-sectional view of a rear support body;

FIG. 5 is a schematic side view illustrating movement of a sub-frame and the heat exchanger at the time of a front collision;

FIG. 6 is a schematic side view of a vehicle front structure illustrating a modification; and

FIG. 7 is a schematic side view of a vehicle front structure illustrating a modification.

### DETAILED DESCRIPTION

In the electric vehicle described in JP-A 2013-193651, since the heat exchanger is disposed in a vertical posture, it is necessary to ensure a large vertical dimension necessary for disposing the heat exchanger in the motor room. Therefore, it is difficult to reduce the vertical dimension of the motor room or to create a space for disposing another apparatus above the heat exchanger in the motor room.

Here, it is conceivable to mount the heat exchanger obliquely in a side view, but in this case, since the rear end of the heat exchanger approaches the motor, the heat exchanger may come into contact with the motor at the time of front collision of the vehicle. Since the heat exchanger is constituted by a conductor, the heat exchanger needs to be designed so as not to come into contact with the motor at the time of collision.

The disclosure has been made in view of the above circumstances, and it is desirable to provide a vehicle front structure capable of reducing a vertical dimension necessary for arrangement of a heat exchanger in a motor room and avoiding contact between the heat exchanger and a motor at the time of a front collision of the vehicle.

In the following, an embodiment of the disclosure is described in detail with reference to the accompanying drawings. Note that the following description is directed to an illustrative example of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiment which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same numerals to avoid any redundant description.

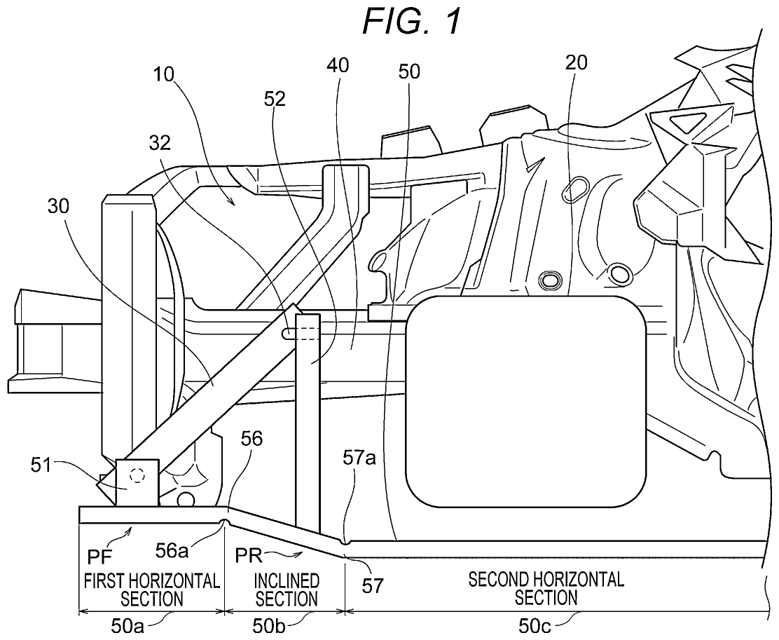

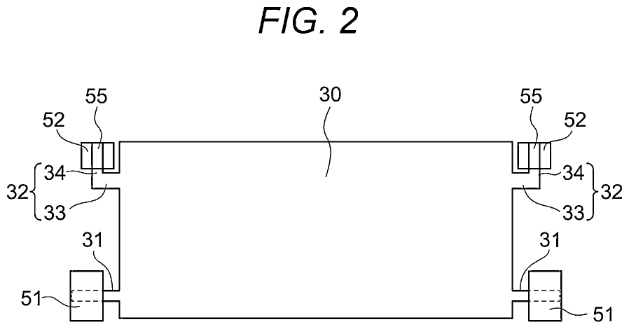

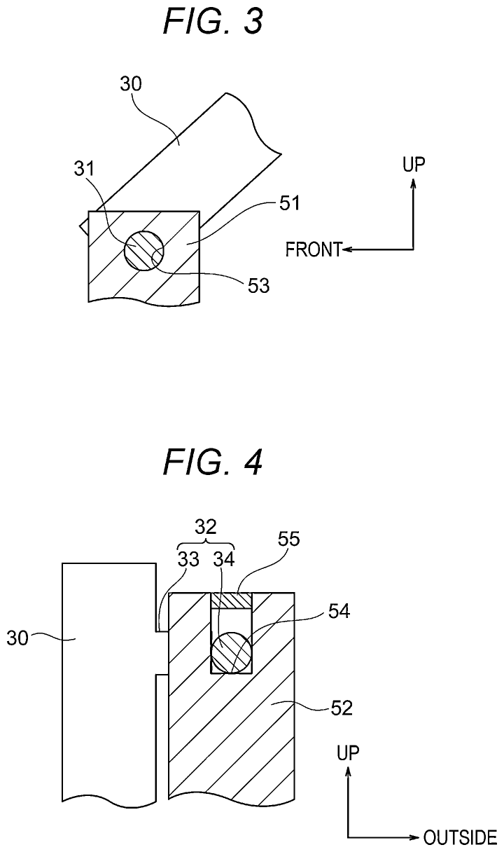

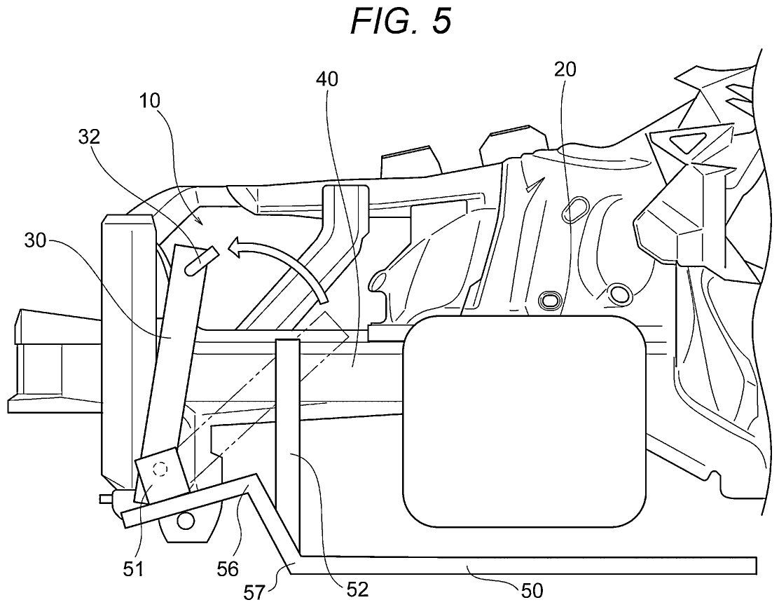

FIGS. 1 to 5 illustrate an embodiment of the disclosure. FIG. 1 is a schematic side view of a vehicle front structure. FIG. 2 is a front view of a heat exchanger. FIG. 3 is a side cross-sectional view of a front support body. FIG. 4 is a rear cross-sectional view of a rear support body. FIG. 5 is a schematic side view illustrating movement of a sub-frame and the heat exchanger at the time of a front collision.

The automobile vehicle is an electric vehicle, and as illustrated in FIG. 1, a driving motor 20 is disposed in a motor room 10 at the front of the vehicle. In the motor room 10, a heat exchanger 30 for cooling the motor 20 is disposed in front of the motor 20. The heat exchanger 30 is disposed in a rear upward posture as viewed in a side view. An automobile vehicle includes a pair of left and right side frames 40 extending in a front-rear direction and forming a frame of the vehicle, and a pair of left and right sub-frames 50 extending in the front-rear direction and to which suspensions, accessories, and the like are attached. In the present embodiment, the heat exchanger 30 is supported by each sub-frame 50, and each sub-frame 50 functions as a support frame of the heat exchanger.

As illustrated in FIG. 2, heat exchanger 30 is formed in a horizontally long rectangular shape in a front view, and performs heat exchange between air and cooling water. In each drawing, details of the heat exchanger 30, such as a pipe portion through which the cooling water flows and a fin connected to the pipe portion, are omitted for the sake of description. The heat exchanger 30 includes front supported portions 31 and rear supported portions 32 one each at left and right ends. Each front supported portion 31 and each rear supported portion 32 are supported by a front support body 51 and a rear support body 52 of each sub-frame 50.

Each front supported portion 31 extends in a left-right outward direction from the front left or right end. In the present embodiment, each front supported portion 31 is formed in a columnar shape with a left-right direction as an axis. As illustrated in FIG. 3, each front supported portion 31 is received in a receiving hole 53 of the front support body 51 of each sub-frame 50. Thus, each front supported portion 31 can rotate about the left-right direction with respect to the front support body 51.

In the present embodiment, each rear supported portion 32 includes an outer extending portion 33 extending in a left-right outward direction from a left or right end on the rear side, and a rear extending portion 34 extending rearward from an outer end of the outer extending portion 33. The outer extending portion 33 and the rear extending portion 34 are formed to have a circular cross section. As illustrated in FIG. 4, the rear extending portion 34 of each rear supported portion 32 is received in a receiving trench 54 of the rear support body 52 of each sub-frame 50. As illustrated in FIG. 1, the sub-frame 50 includes a front bent portion 56 that is bent in a mode to protrude upward and a rear bent portion 57 that is bent in a mode to protrude downward when a compressive load in the front-rear direction is applied to the sub-frame 50. The sub-frame 50 has a horizontal first horizontal section 50a, a backward descending inclined section 50b, and a horizontal second horizontal section 50c in this order from the front end toward the rear. In the present embodiment, a boundary portion between the first horizontal section 50a and the inclined section 50b forms the front bent portion 56, and a boundary portion between the inclined section 50b and the second horizontal section 50c forms the rear bent portion 57. The front bent portion 56 and the rear bent portion 57 each have a first groove 56a and a second groove 57a as fragile portions that facilitate bending. The first groove 56a is formed on a lower surface of a main body of the sub-frame 50 so as to extend in the left-right direction, and the second groove 57a is formed on an upper surface of the main body of the sub-frame 50 so as to extend in the left-right direction.

The front support body 51 of the sub-frame 50 is disposed at a front support position PF in front of the front bent portion 56. In the present embodiment, the front support body 51 is fixed to the upper surface of the main body of the sub-frame 50. As described above, the front support body 51 has the receiving hole 53 that receives the front supported portion 31, and allows rotation of the front supported portion 31 of the heat exchanger 30 about the left-right direction as an axis when the front bent portion 56 and the rear bent portion 57 are bent.

The rear support body 52 of the sub-frame 50 is disposed at a rear support position PR between the front bent portion 56 and the rear bent portion 57. In the present embodiment, the rear support body 52 is fixed to the upper surface of the main body of the sub-frame 50 and extends upward from the sub-frame 50. As described above, the rear support body 52 has the receiving trench 54 that receives the rear supported portion 32 on the upper surface, and allows the rear supported portion 32 of the heat exchanger 30 to move upward when the front bent portion 56 and the rear bent portion 57 are bent. That is, the rear support body 52 is configured so that the rear supported portion 32 is detached from the rear support body 52 when the front bent portion 56 and the rear bent portion 57 of the sub-frame 50 are bent. In the present embodiment, a pressing member 55 is provided in an upper portion in the receiving trench 54, and usually, the rear supported portion 32 is not detached from the rear support body 52. Note that the pressing member 55 can be appropriately omitted.

In the vehicle front structure configured as described above, since the heat exchanger 30 is disposed obliquely in side view, it is possible to reduce the vertical dimension for disposing the heat exchanger 30 in the motor room 20. Thus, the vertical dimension of the motor room 20 can be reduced, and a space for arranging another apparatus above the heat exchanger 30 in the motor room 20 can be created. Therefore, the degree of freedom in vehicle design increases, and product strength of the vehicle can be improved.

When a compressive load in the front-rear direction acts on each of the sub-frames 50 at the time of a front collision of the vehicle, as illustrated in FIG. 5, the front bent portion 56 is bent upward convexly and the rear bent portion 57 is bent downward convexly, whereby each of the sub-frames 50 absorbs energy at the time of collision. At this time, the rear supported portion 31 of the heat exchanger 30 is separated from the rear support body 52 of the sub-frame 50, so that the rear end side of the heat exchanger 30 is movable with respect to the sub-frame 50. Since the front bent portion 56 of the sub-frame 50 rises, the rear end side of the first horizontal section 50a of each sub-frame 50 rises, and accordingly, the rear end side of the heat exchanger 30 also rises. As a result, the heat exchanger 30 comes close to a vertical posture from the initial rear upward posture in the side view, and the distance between the heat exchanger 30 and the motor 20 in the front-rear direction is ensured at the time of the front collision, and the contact therebetween can be avoided.

In the present embodiment, since the rear end support body 52 is disposed between the front bent portion 56 and the rear bent portion 57, it is relatively easy for a mode in which the rear support body 52 moves downward to occur when each sub-frame 50 is bent. By the mode in which the rear support body 52 moves downward occurring at the time of the front collision, the rear supported portion 32 of the heat exchanger 30 received in the receiving trench 54 can be reliably moved upward and separated from the rear support body 52. In this way, in a state where the rear supported portion 32 is separated from the rear support body 52, the front support body 51 allows the rotation of the front supported portion 31 about the left-right direction as an axis, so that the heat exchanger 30 is rotatable about the front supported portion 31 as an axis, and the posture of the heat exchanger 30 can be smoothly changed at the time of the front collision.

In the present embodiment, the front bent portion 56 and the rear bent portion 57 have a first groove 56a and a second groove 57a as the fragile portions, respectively. It is possible to reliably cause the sub-frames 50 to be bent at the front bent portion 56 and the rear bent portion 57 at the time of the front collision. Thus, deformation and posture change of each sub-frame 50 and the heat exchanger 30 at the time of the front collision are stabilized.

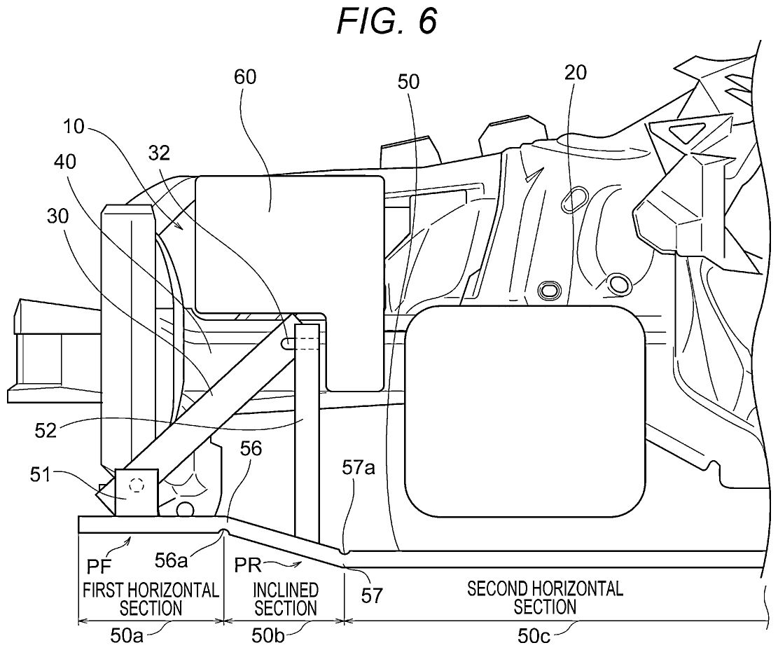

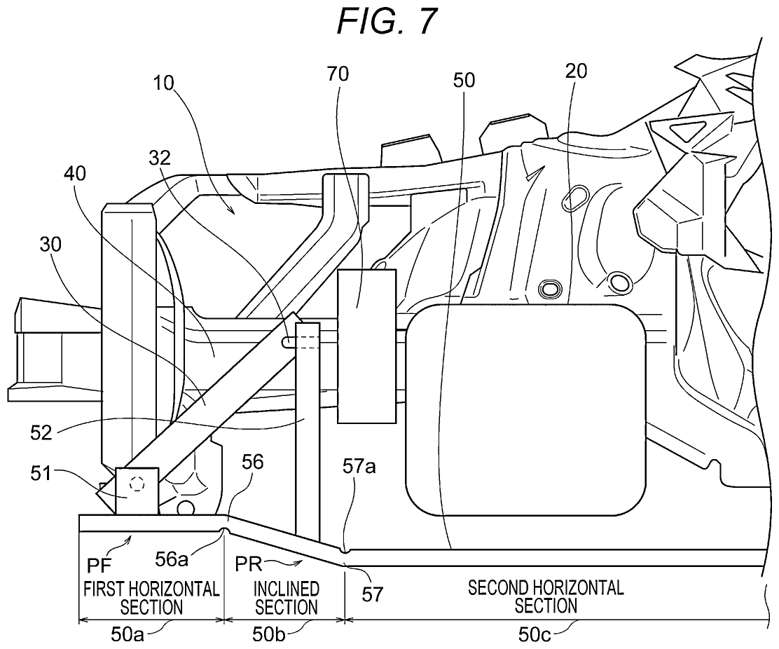

In the above embodiment, the example in which there is a space between the heat exchanger 30 and the motor 20 has been described, but as illustrated in FIGS. 6 and 7, for example, by disposing a component formed by a non-conductive material between the heat exchanger 30 and the motor 20, it is possible to further stabilize the posture change of the heat exchanger 30 while protecting the motor 20 from the heat exchanger 30 at the time of the front collision. FIG. 6 illustrates an example in which a part of a housing portion 60 disposed above the heat exchanger 30 is formed to protrude between the heat exchanger 30 and the motor 20. FIG. 7 illustrates an example in which a reservoir tank 70 of the cooling water flowing through the motor 20 and the heat exchanger 30 is disposed between the heat exchanger 30 and the motor 20.

In the above embodiment, the example in which only the motor 20 is disposed as the drive source of the vehicle in the motor room 10 has been described, but a hybrid vehicle in which an engine is disposed in addition to the motor 20 may be used.

In the above embodiment, the example in which the cylindrical front supported portion 31 of the heat exchanger 30 is received in the receiving hole 53 of the front support body 51 of the sub-frame 50 has been described. However, for example, a bolt that is screwed with the front support body 51 and projects toward the heat exchanger 30 may be provided, and a receiving hole of the bolt may be formed in the heat exchanger 30. In this case, the receiving hole of the heat exchanger 30 forms the front supported portion, and also in this case, the front supported portion can rotate about the left-right direction as an axis with respect to the front support body. It is desirable that the front supported portion 31 of the heat exchanger 30 is rotatably supported by the front support body 51 of the sub-frame 50, but the front supported portion need not be rotatable as long as the posture change of the heat exchanger 30 is sufficiently implemented by deformation of the sub-frame 50 and the like at the time of the front collision. The detailed structure of the rear support body 52 can be changed in any manner as long as the rear supported portion 32 is configured to be detached from the rear support body 52 when the front bent portion 56 and the rear bent portion 57 of the sub-frame 50 are bent.

In the above embodiment, the example in which the heat exchanger 30 is supported by the sub-frame 50 has been described, but a support frame for the heat exchanger may be provided separately from the sub-frame 50. Although the example in which the front bent portion 56 and the rear bent portion 57 of the sub-frame 50 have the first groove 56a and the second groove 57a has been described, the fragile portion may be formed of a bead, a long hole, or the like. Further, even if the fragile portion is not provided, the fragile portion can be omitted as long as the front bent portion 56 and the rear bent portion 57 located at the boundary between the horizontal section and the inclined section are reliably bent at the time of the front collision.

Although the embodiments of the present disclosure have been described above, the embodiments described above do not limit the disclosure according to the claims. It should be noted that not all combinations of features described in the embodiments are related to the means for solving the problems of the disclosure.

According to the vehicle front structure of the present disclosure, it is possible to reduce the vertical dimension for disposing the heat exchanger in the motor room, and to avoid contact between the heat exchanger and the motor in the event of a front collision of the vehicle.

1. A vehicle front structure in which a heat exchanger is disposed in front of a motor in a motor room, the vehicle front structure comprising
support frames in a left and right pair, the support frames extending in a front-rear direction and respectively supporting left and right ends of the heat exchanger, wherein
the heat exchanger comprises a front supported portion and a rear supported portion that are disposed in a rear upward posture in a side view, are disposed at left and right ends, and are supported by the support frames,
each of the support frames comprises a front support body and a rear support body that support the front supported portion and the rear supported portion of the heat exchanger,
the each of the support frames comprises a front bent portion and a rear bent portion, that are respectively configured to be bent in a mode of protruding upward and to be bent in a mode of protruding downward when a compressive load in the front-rear direction acts on the each of the support frames,
the front support body is disposed in front of the front bent portion,
the rear support body is configured such that the rear supported portion is detached from the rear support body when the front bent portion and the rear bent portion are bent, and
the heat exchanger is configured to approach a vertical posture from the rear upward posture in a side view when the front bent portion and the rear bent portion are bent.

2. The vehicle front structure according to claim 1, wherein the rear support body is disposed between the front bent portion and the rear bent portion.

3. The vehicle front structure according to claim 2, wherein
the front support body allows the front supported portion of the heat exchanger to rotate about a left-right direction as an axis when the front bent portion and the rear bent portion are bent, and
the rear support body allows the rear supported portion of the heat exchanger to move upward when the front bent portion and the rear bent portion are bent.

4. The vehicle front structure according to claim 3, wherein the front bent portion and the rear bent portion each comprise a fragile portion disposed in the each of the support frames.

5. The vehicle front structure according to claim 1, further comprising a component disposed between the heat exchanger and the motor, the component comprising a non-conductive material.

6. The vehicle front structure according to claim 2, further comprising a component disposed between the heat exchanger and the motor, the component comprising a non-conductive material.

7. The vehicle front structure according to claim 3, further comprising a component disposed between the heat exchanger and the motor, the component comprising a non-conductive material.

8. The vehicle front structure according to claim 4, further comprising a component disposed between the heat exchanger and the motor, the component comprising a non-conductive material.
